(19) United States
(12) Patent Application Publication
(10) Pub. No.: US 2007/0039000 A1
(43) Pub. Date: Feb. 15, 2007

(54) Lock order determination method and system

(75) Inventors: Shashi Kanth Lakshmikantha, Sunnyvale, CA (US); Robert Johnson, Santa Cruz, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/200,031

(22) Filed: Aug. 10, 2005

(51) Int. Cl. G06F 9/46; G06F 12/14

(52) U.S. Cl. 718/100; 710/200

(57) ABSTRACT

A lock order determination method and system are described. A thread is executed including an attempt to acquire a lock. The highest lockorder held by a thread prior to attempting to acquire the lock is determined. The lockorder for the lock relative to the determined highest lockorder held is set. The system for determining a lockorder for a lock includes a find lockorder function in a thread of executable instructions arranged to store a lockorder held by the thread accessing the find lockorder function.

### FIELD OF THE INVENTION

The present invention relates to a lock order determination method and system.

### BACKGROUND

Processes may be typical programs such as word processors, spreadsheets, games, or web browsers. Processes are also underlying tasks executing to provide additional functionality to either an operating system or to the user of the computer. Processes may also be processes of the operating system for providing functionality to other parts of the operating system, e.g., networking and file sharing functionality.

Processes executing on a processor, i.e., processes interacting with the kernel, are also known as execution threads or simply “threads.” A thread is the smallest unit of scheduling on an operating system. Normally, each process (application or program) has a single thread; however, a process may have more than one thread (sometimes thousands). Each thread can execute on its own on an operating system or kernel.

Programmers use software locks (hereafter referred to as locks) in order to synchronize multiple threads of execution needing to access or modify shared or otherwise interdependent data. In complex multithreaded software, multiple locks are acquired and held simultaneously during execution of a thread. In such instances, a lock ordering approach may be used to prevent a first executing thread from acquiring a lock out of order and potentially preventing a second executing thread from executing.

For example, FIG. 1 depicts a high level example of two threads of execution 100, 102 acquiring software locks and resulting in a deadlock in which neither thread can continue to execute due to the other thread retaining the lock needed by the other thread. In FIG. 1, time proceeds downward along the page from top to bottom. As depicted in FIG. 1, a processor executes thread 100 causing the thread to acquire a first lock at portion 104 of the thread execution. The processor executing thread 102 causes the thread to acquire a second lock at portion 106 of the thread execution. At portion 108 of thread 100 execution, the thread attempts to acquire a second lock; however, the second lock was previously acquired by portion 106 of thread 102. At this point, thread 100 cannot proceed with execution until the second lock is released by thread 102. If thread 102 releases the second lock, thread 100 may proceed with execution after obtaining the second lock.

To make matters worse, thread 102 at portion 110 attempts to acquire the first lock. However, the first lock was previously acquired by portion 104 of thread 100 and has not been released. Additionally, the first lock will not be released by thread 100 until the attempt to acquire the second lock completes. Because thread 102 retains the second lock, thread 100 cannot acquire the second lock and because thread 100 retains the first lock, thread 102 cannot acquire the first lock. In this instance, threads 100, 102 are deadlocked waiting for the other to release a lock.

The prioritizing or ordering of software locks has been used to prevent the above-described deadlocks from occurring. Each lock has a lockorder value (also referred to simply as a lockorder) assigned which determines whether the executing thread is able to acquire another lock. That is, an executing thread may only acquire locks in, for example, an increasing order of value, e.g., thread 100 may acquire locks 1, 2, 6, and 8 and not 1, 8, 6, and 2. If additional locking is required, the acquisition of the new lock by the executing thread must be performed in such a manner as to avoid a deadlock condition preventing execution of the thread or other threads.

When using lockorders to avoid deadlocks, a developer, e.g., a programmer, software designer, etc., selects a new lockorder greater than the lockorder of any lock currently held by an executing thread. In the above-described example with respect to FIG. 1, assuming that the lockorder of the first lock is 1 and the lockorder of the second lock is 2, the attempt by thread 102 to acquire the first lock (portion 110) while holding the second lock is a violation of the defined locking order based on lockorder value and is detectable as a potential deadlock.

Current processes for selecting appropriate lockorders for locks for determining that multithreaded code is safe from deadlocks is time-intensive, manual, and error-prone.

For example, developers need to know which other locks are held at each point where the new lock may be acquired. Processes for determining the correct ordering of locks include manually inspecting software for paths in which the new lock is used, selecting a lockorder for the new lock and testing the software with the lockorder to determine if a deadlock occurs.

The process is laborious and prone to errors as the lock that is already held may be held many levels above in the calling sequence of the software. Additionally, a large amount of work is required to inspect software in all the different paths concerned and easy to miss a path of execution.

The lock could be acquired in one function and released in another function. This means that in each path, the developer needs to perform a recursive search of all the functions being used at each level. Again, the process is laborious and it is easy to miss locks held.

Further, the software paths may not be software with which the developer is familiar. For example, some locks are held across sub-systems and the developer may have to review unfamiliar software to identify locks held.

Failures during testing due to potential deadlock provide only partial information. Selecting a new lockorder and testing again is time-consuming and the testing may have to be repeated many times.

The current way for developers to find the lockorder for a new lock can be a laborious task and a time consuming one, and in many cases prone to errors.

### SUMMARY

The present invention provides a lock order determination method and system.

A method embodiment includes a thread executed including an attempt to acquire a lock. The highest lockorder held by a thread prior to attempting to acquire the lock is determined. The lockorder for the lock relative to the determined highest lockorder held is set.

A system embodiment includes a find lockorder function arranged to store a lockorder held by a thread of executable instructions accessing the find lockorder function.

Still other advantages of the embodiments will become readily apparent to those skilled in the art from the following detailed description, wherein the preferred embodiments are shown and described, simply by way of illustration of the best mode contemplated of carrying out the invention. As will be realized, the invention is capable of other and different embodiments, and its several details are capable of modifications in various obvious respects, all without departing from the invention.

### DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a high level diagram of a deadlock between two executing threads;

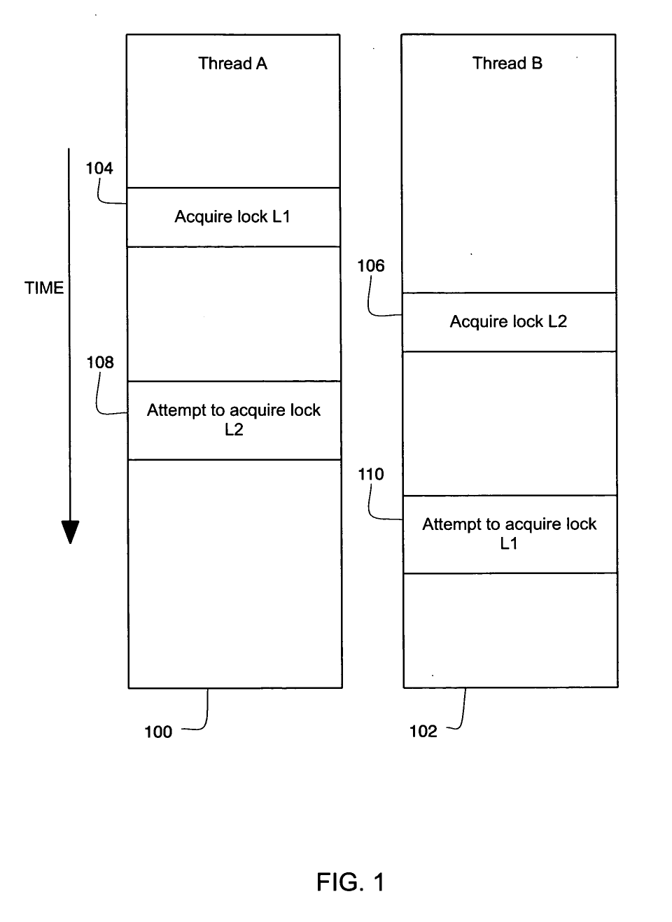

FIG. 2 is a high level functional flow diagram of an embodiment;

FIG. 3 is a high level functional flow diagram of another embodiment; and

FIG. 4 is a high level functional block diagram of a computer system usable in conjunction with the FIG. 2 embodiment.

### DETAILED DESCRIPTION

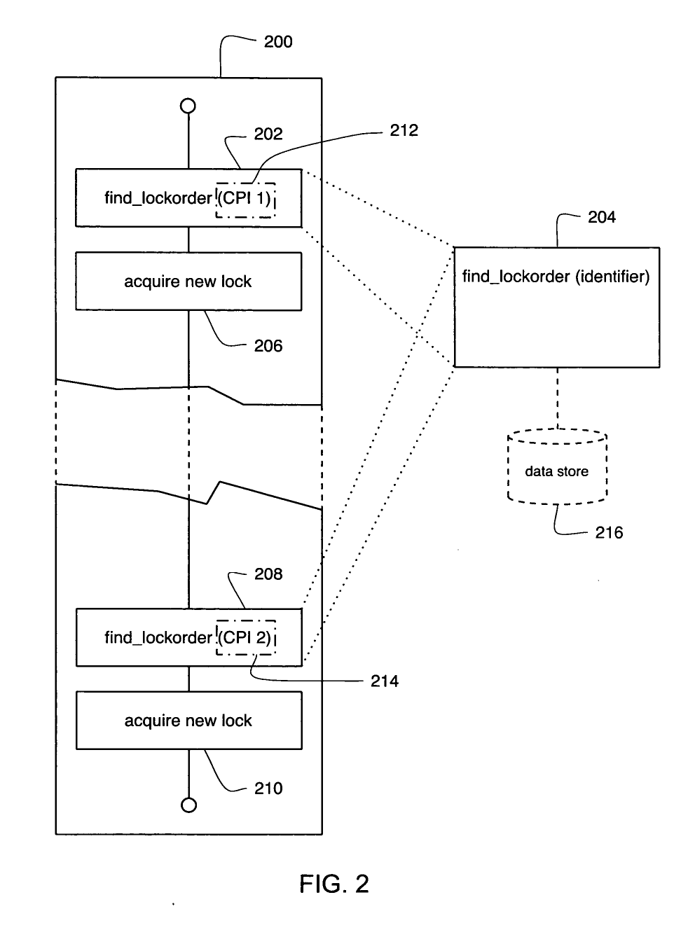

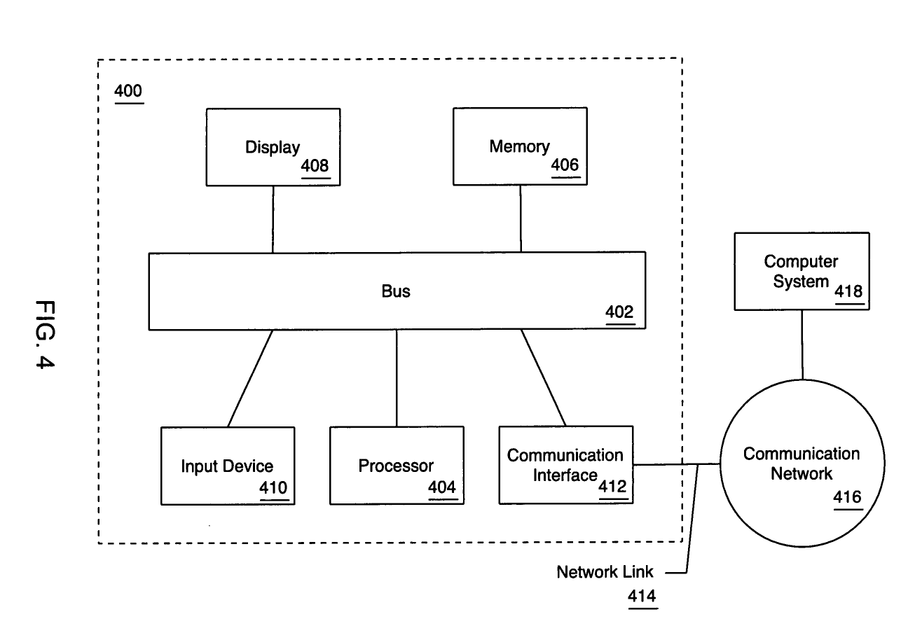

FIG. 2 depicts a high level functional flow diagram of an embodiment in which a thread 200 includes a call 202 to a new function, i.e., find_lockorder function 204, for recording the lockorder value currently held by the thread prior to execution of a lock acquisition function 206 for attempting to acquire a new software lock. In this manner, the largest lockorder value held by thread 200 may be recorded prior to acquisition of the new lock. Analysis of the recorded lockorder values enables determination of an appropriate lockorder value for the new lock. Thread 200 includes processes executed by a processor, e.g., processor 404 of a computer system 400 described in detail below with reference to FIG. 4, and may include application software, operating system software, and others.

With reference to FIG. 2, thread 200 includes a number of function calls, depicted conceptually in FIG. 2, executed by processor 404 during execution of the thread, e.g., find_lockorder call 202, acquire new lock call 206, find_lockorder call 208, acquire new lock call 210, etc. Additional function calls in thread 200 have been removed from FIG. 2 to improve clarity. Find_lockorder 202 and 208 and acquire new lock 206 and 210, respectively, are function calls to the same functions occurring at different locations in the thread 200 functional flow.

A processor executing the instructions making up thread 200 causes execution of find_lockorder call 202. Find_lockorder call 202 initiates execution of the find_lockorder function 204 and passes a calling point identifier 212 (dash-dot line), i.e., an identifier indicating the location of the find_lockorder call 202 in thread 200, of the function call, e.g., a numeric identifier, a line number, a memory address, etc. Calling point identifier 212 uniquely identifies the location of the find_lockorder call 202 in thread 200 and calling point identifier 214 (dash-dot line) uniquely identifies the location of the find_lockorder call 208 in thread 200. Calling point identifier 212 may be an alphanumeric, numeric, alphabetic, and other character representation.

In different embodiments, find_lockorder function 204 is a separately executable process, a compiled additional functional portion of thread 200, or a portion of an operating system on which the thread is executing.

Processor 404 executing find_lockorder function 204 as a result of find_lockorder call 202 receives calling point identifier 212 as an input to the function execution. Listing 1 below is a pseudo-code listing of an exemplary algorithm for find_lockorder function 204. Line numbers have been added for reference purposes only. Additional embodiments employ different algorithms for find_lockorder function 204 while remaining within the scope of the described embodiments.

Line 1 of the listing identifies the function call, as well as, the parameter provided to the function, i.e., calling point identifier (ID) 212. Lines 2 and 3 describe tests applied to information related to thread 200 and the current execution of the thread. If in line 2, the calling thread 200 does not hold any locks, there is a larger range of values possible for the lockorder value of the new lock. If in line 3 calling point ID 212 and lockorder value pair is unique, the currently executing path of execution through thread 200 has not been executed previously. That is, if the calling point ID 212 and lockorder value pair is not unique, the equivalent data is already stored. If the lines 2 and 3 tests succeed, line 4 causes the recording of the largest lockorder value currently held by thread 200.

Listing 1

1 find_lockorder (calling point ID) {

| | |
|---|---|
| 2 | if the calling thread currently holds any locks { |

| | |
|---|---|
| 3 | if the (calling point ID, lockorder value) pair is unique { |

| | |
|---|---|
| 4 | store the value of the largest order lock held by the calling thread |

| | |
|---|---|
| 5 | } |

| | |
|---|---|
| 6 | } |

7 }

During execution of an embodiment by processor 404, the same calling point ID 212 may be encountered multiple times by find_lockorder function 204. In such an embodiment, if the lockorder value held at the same calling point ID 212 is the same as previous occurrences, then the lockorder value is not stored; however, in other embodiments, the lockorder value is stored regardless of the calling point ID 212 encountered. In an embodiment storing the calling point ID 212 along with the largest lockorder value held, the calling point ID 212 information is useful for an understanding of the thoroughness of the testing applied to thread 200.

In another embodiment, unique combinations of calling point ID 212 and largest lockorder value held at the time of the call 202 are stored. In accordance with this embodiment, at the time of the call 202 execution, several locks may be held and information pertaining to the largest lockorder value is desired to be stored. As described below, in additional embodiments, additional relevant data may be stored regarding the lock.

In an embodiment, calling point ID 212 and the lockorder value provided to find_lockorder function 204 are stored in an optional data store 216 (dashed line). In another embodiment, find_lockorder function 204 stores the lockorder value in optional data store 216 without storing the calling point ID 212.

After execution of find_lockorder function 204 by processor 404, the processor executes acquire new lock call 206 and acquires the lock for which a lockorder value is to be determined.

In operation, the above-described embodiment is applied to executable software (not shown) executed by computer system 400, i.e., find_lockorder call 202 is added to the executable software instruction set prior to acquire new lock function 206. Executable software including thread 200 is then exercised thoroughly with functional and stress tests. That is, different combinations of input and input timing and values are provided to thread 200 in order to cause one or more portions of the thread to execute. The testing load forces execution of instrumented paths, i.e., threads having find_lockorder call 202 prior to the acquire new lock function 206, and the result of storing the largest lockorder value held by thread 200 at various points of execution will enable determination of the largest lockorder value held during each path execution. Manual inspection may still be used to determine the largest lock order value held in non-executed paths including a find_lockorder call 202.

After testing completes, data collected by find_lockorder function 204 is extracted and displayed by a tool to a user, e.g., using display 408. The information for each calling point includes:
whether or not each instrumented path was executed; and
if executed, and if other locks are held at that point, details about the lock with the largest lockorder: exact lockorder, name of lock and the location where the other lock was acquired.

With this lockorder information, a new lockorder is assigned to the new lock by using a number slightly larger than the lockorder of any lock previously held.

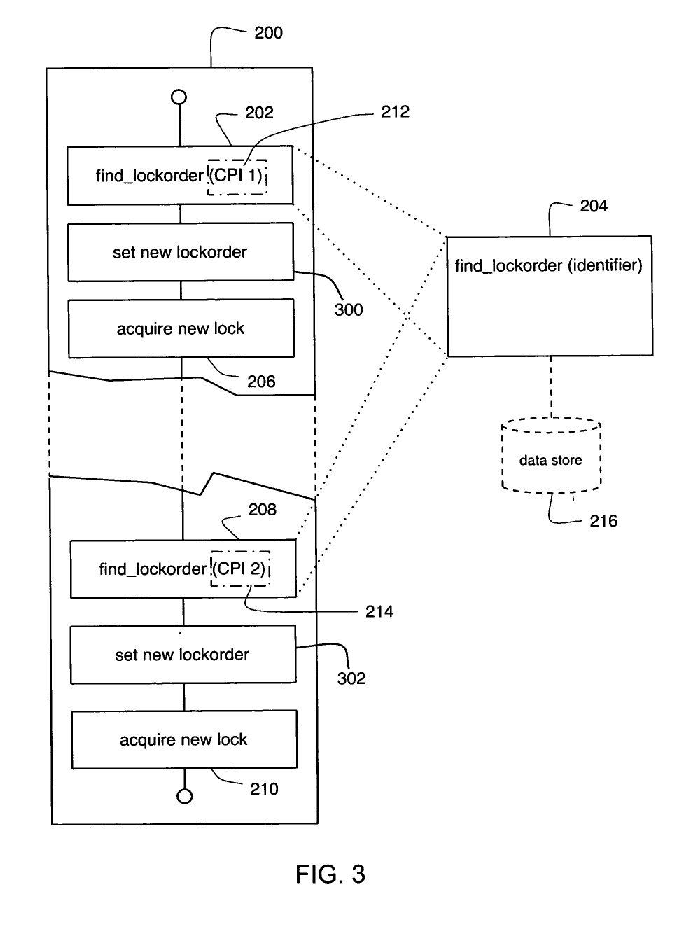

FIG. 3 is a high level functional flow diagram of another embodiment in which a set new lockorder function 300 is caused to execute between the execution of find_lockorder call 202 and acquire new lock function 206. Similarly, set new lockorder function 302 executes between find_lockorder call 208 and acquire new lock function 210. Processor 404 executing set new lockorder function 302 causes a lockorder value for the new lock to be acquired to be dynamically set prior to execution based on the current largest lockorder value held by thread 200. In an embodiment, set new lockorder function 300 may set the lockorder value to one greater than the largest lockorder value held at the time by thread 200.

FIG. 4 is a block diagram illustrating an exemplary computer system 400 upon which an embodiment may be implemented. Computer system 400 includes a bus 402 or other communication mechanism for communicating information, and a processor 404 coupled with bus 402 for processing information. Computer system 400 also includes a memory 406, such as a random access memory (RAM) or other dynamic storage device, coupled to the bus 402 for storing instructions to be executed by processor 404. Memory 406 also may be used for storing lockorder values and calling point identifiers, temporary variables or other intermediate information during execution of instructions to be executed by processor 404.

Computer system 400 is coupled via bus 402 to display 408, such as a liquid crystal display (LCD) or other display technology, for displaying information to the user. Input device 410, described above, is coupled to bus 402 for communicating information and command selections to the processor 404.

According to one embodiment, computer system 400 operates in response to processor 404 executing sequences of instructions contained in memory 406 and responsive to input received via input device 410, or communication interface 412. Such instructions may be read into memory 406 from a computer-readable medium or communication interface 412.

Execution of the sequences of instructions contained in memory 406 causes the processor 404 to perform the process steps described above. In alternative embodiments, hard-wired circuitry may be used in place of or in combination with computer software instructions to implement the embodiments. Thus, embodiments are not limited to any specific combination of hardware circuitry and software.

Computer system 400 also includes a communication interface 412 coupled to the bus 402. Communication interface 412 provides two-way data communication. For example, communication interface 412 may be a wireless communication link. In any such implementation, communication interface 412 sends and receives electrical, electromagnetic or optical signals which carry digital data streams representing various types of information. Of particular note, the communications through interface 412 may permit transmission or receipt of lockorder values and calling point identifiers for display on display 408.

Network link 414 typically provides data communication through one or more networks to other devices. For example, network link 414 may provide a connection through communication network 416 to computer system 400 or to data equipment operated by a service provider (not shown). The signals through the various networks and the signals on network link 414 and through communication interface 412, which carry the digital data to and from computer system 400, are exemplary forms of carrier waves transporting the information.

Computer system 400 can send messages and receive data, including program code, through the network(s), network link 414 and communication interface 412. Received code may be executed by processor 404 as it is received, and/or stored in memory 406 for later execution. In this manner, computer system 400 may obtain application code in the form of a carrier wave.

In a prototype of the above-described embodiment, out of 28 different paths of execution, the embodiment found the lockorder for 23 paths. 5 paths had to be manually inspected. Of the 5 manually inspected paths, 3 paths leveraged information collected for the 23 paths. Execution according to the above-described embodiments resulted in significant savings in effort and time as compared to prior approaches. Further, a technical contribution is made by the above-described embodiments in determining, setting, and/or modifying the lockorder value of a lock.

It will be readily seen by one of ordinary skill in the art that the embodiments fulfill one or more of the advantages set forth above. After reading the foregoing specification, one of ordinary skill will be able to affect various changes, substitutions of equivalents and various other aspects of the embodiments as broadly disclosed herein. It is therefore intended that the protection granted hereon be limited only by the definition contained in the appended claims and equivalents thereof.

What is claimed is:

1. A method of determining a lockorder for a lock, comprising:
executing a thread of executable instructions including an attempt to acquire a lock;
determining the highest lockorder held by the thread prior to attempting to acquire the lock; and
setting the lockorder for the lock relative to the determined highest lockorder held.

2. A method as in claim 1, wherein the determining step comprises:
storing the highest lockorder held and a calling point identifier indicative of the location of the attempt to acquire the lock within the executing thread.

3. A method as in claim 1, further comprising:
setting an initial lockorder for the lock prior to executing the thread; and
wherein the setting the lockorder step comprises modifying the initial setting of the lockorder for the lock relative to the determined highest lockorder held.

4. A method as in claim 1, comprising:
repeating the executing and determining steps prior to performing the setting step.

5. A method as in claim 1, wherein the setting step comprises setting the lockorder for the lock to one more than the determined highest lockorder held.

6. A method as in claim 1, wherein the executing step comprises:
setting a new lockorder prior to attempting to acquire the lock.

7. A system for determining a lockorder for a lock, comprising:
a find lockorder function in a thread of executable instructions arranged to store a lockorder held by the thread accessing the find lockorder function.

8. A system as in claim 7, wherein the find lockorder function is arranged to store a calling point identifier indicative of the location of the attempt to acquire a lock within the executable instructions.

9. A system as in claim 7, comprising:
a set lockorder function arranged to set the lockorder for the lock relative to the lockorder stored by the find lockorder function.

10. A system as in claim 9, wherein the lockorder set by the set lockorder function is greater than the largest value stored by the find lockorder function.

11. A system as in claim 9, wherein the find lockorder function is arranged to execute one or more times prior to execution of the set lockorder function.

12. A system as in claim 7, comprising:
an initial lockorder set function arranged to set an initial lockorder for the lock prior to executing the thread.

13. A system as in claim 12, comprising:
a set lockorder function arranged to modify the initial lockorder for the lock relative to the lockorder stored by the find lockorder function.

14. A system as in claim 13, wherein the set lockorder function is arranged for execution prior to an acquire new lock function.

15. A computer-readable medium storing instructions which, when executed by a processor, cause the processor to implement the method of determining a lock order for a lock as claimed in claim 1.

16. A computer system configured to implement the method of determining a lock order for a lock as claimed in claim 1.

17. A lockorder determination system, comprising:
thread execution means for executing a thread of executable instructions including an attempt to acquire a lock; and
lockorder determining means for determining a highest lockorder held by the thread executed by the thread execution means prior to attempting to acquire the lock.

18. A system as in claim 17, wherein the lockorder determining means includes the ability to store a calling point identifier indicative of the location of the attempt to acquire the lock within the executable instructions.

19. A system as in claim 17, comprising:
lockorder setting means for setting the lockorder for the lock to be acquired relative to the lockorder determined by the lockorder determining means.

20. A system as in claim 19, comprising:
lockorder initialization means for setting an initial lockorder for the lock prior to thread execution; and
wherein the lockorder setting means further comprises modifying the initial setting of the lockorder for the lock to be acquired relative to the highest lockorder held determined by the lockorder determining means.
